(19) United States
(12) Patent Application Publication
(10) Pub. No.: US 2004/0127358 A1
(43) Pub. Date: Jul. 1, 2004

(54) Versatile oxygen sorbents and devices

(76) Inventors: Michael E. DeRosa, Painted Post, NY (US); Mingqian He, Painted Post, NY (US); Yuming Xie, Painted Post, NY (US)

Correspondence Address: CORNING INCORPORATED, SP-TI-3-1, CORNING, NY, 14831

(21) Appl. No.: 10/607,251

(22) Filed: Jun. 25, 2003

Related U.S. Application Data
(60) Provisional application No. 60/391,859, filed on Jun. 25, 2002.

(51) Int. Cl. B01J 20/02

(52) U.S. Cl. 502/406

(57) ABSTRACT

The invention according to one aspect provides oxygen sorbent materials, which are able to remove trace amounts of oxygen in either a gas-flow or an enclosed system over a wide temperature range. In particular, the invention relates to bulk solid oxygen sorbents that can lower equilibrium oxygen concentrations to below 1 part per trillion (1 ppt). The oxygen sorbents have high surface area, nano-sized crystalline mixed oxides that include cerium oxide, zirconium oxide and preferably yttrium oxide, and an aliquot of catalytic materials such as precious metal. The present sorbents can work in noxious environments, since the materials are not sensitive to toxic elements, which would typically poison conventional catalysts. In another aspect, a product and method for fabricating an opto-electronic device that includes a getter material, incorporating an iteration of the sorbent material, is provided. The getter material operates by bulk transport and has a capacity to absorb and retain large quantities of oxygen per volume and other contaminants over a wide temperature range. This is a useful feature for opto-electronic—also known as photonic—devices, especially those with polymeric components, since they often suffer from photo-degradation caused by the presence of gaseous oxygen and other contaminants in the optical pathway.

### CROSS-REFERENCE TO RELATED APPLICATIONS

The present application claims benefit of priority to U.S. Provisional Patent Application No. 60/391,859, filed Jun. 25, 2002, and is related to co-assigned U.S. Provisional Patent Application No. 60/386,155, filed Jun. 4, 2002, the content of each application which is incorporated herein.

### FIELD OF THE INVENTION

The invention pertains in part to a family of oxygen sorbent materials, which are able to remove trace amounts of oxygen in either a gas-flow or an enclosed system over a wide temperature range. In particular, the invention relates to bulk solid oxygen sorbents that can lower equilibrium oxygen concentrations to below 1 part per trillion (1 ppt). The present invention also pertains to hermetically sealed packages and a means or process of removing oxygen and/or other contaminants from such a sealed enclosure. In particular, the invention relates to getter materials and housings used in packages for polymeric opto-electronic devices and other systems in which oxygen, water, and hydrocarbon vapor can be detrimental to the functions of these devices.

### BACKGROUND

Oxygen removal is one of the most important processes in many industries, especially in the chemical processing industry. The presence of oxygen deactivates catalysts, the performance of which is directly related to their oxidation states. Hence, before the reactants meet the catalysts, oxygen in a reactant stream must be removed completely.

Various approaches have been proposed for sorbing trace amounts of oxygen from either a gaseous flow or an enclosed system. Commercial oxygen sorbents typically remove oxygen by means of oxidization of active components in gaseous oxygen. Currently, three general types of oxygen-sorbents are available. The active components usually are transition metals or metal oxides in reduced states. The reduction chemical activation for these materials, however, operate only within certain limited temperature ranges. Moreover, these sorbent materials have relatively low capacity for oxygen sorption, due to the low amount of active components in the sorbents.

Typically, the active components of these oxygen sorbents are supported on a high surface area substrate, and are designed in a highly dispersed fashion, to remove effectively oxygen within a short contact time period. The nature of high dispersion, however, limits the operation of active components at high temperatures due to the effect of sintering. Moreover, the high dispersion limits the amount of active components that can be loaded on a substrate. Hence, the oxygen sorption capacity of the sorbent is quite limited.

Conventional oxygen sorbents need to be first activated in a reducing environment before use. A drawback of this preparation is that after reduction, the sorbents are highly sensitive to air. Highly dispersed active components are oxidized immediately upon exposure to the air. This high sensitivity mandates that persons working with these materials exercise great care in handling during processing or use. In some applications, for example, oxygen-free packaging, the high sensitivity of the sorbents to oxygen demands a strict operating procedure and increases the overall cost of processing. Hence, there is a great demand for a material that has high oxygen sorption capacity and greater resilience to handling and exposure to the air. For instance, commercial oxygen sorbent (BASF catalyst R-3-11), which is believed to comprise five to six metals deposited on a silica support, has an upper temperature limit of about 200-250° C., and is inactivated or degraded by accidental exposure to atmospheric air at room temperature.

Other sorbents that employ a change of oxidation state of a transitional metal, such as iron, or a mixture of transitional metal oxides, such as cobalt oxide or copper oxide, may react with oxygen under higher temperature conditions. For instance, U.S. Pat. Nos. 5,314,853 and 5,484,580, issued to Sharma, the contents of which are incorporated herein by reference, describe a kind of oxygen sorbent material that contains transitional metals and metal oxides dispersed on high surface area materials such as silica gel, alumina and zeolite. Another kind of oxygen sorbent includes Schiff base-metal complexes, which are usually grafted to a high surface area polymer or impregnated on high-surface area silica gel. Examples of this kind of sorbent are U.S. Pat. Nos. 4,514,522 and 4,654,053, issued to Sievers et al., the contents of which are incorporated herein by reference. The Sievers patents disclose an oxygen sorbent that comprises transitional metal complexes bonded to a porous polymer. U.S. Pat. No. 5,208,335, discloses a high-capacity, solid state cyanocolbaltate complex that can bind oxygen. Lowering the partial pressure of oxygen at near room temperature regenerates this category of reversible oxygen sorbents, which is mostly used in gas separations. Still another kind of sorbent is exemplified by Polish patent PL156956, which discloses a mixture of CuCO₃, MgCO₃ and Ag₂CO₃ formed into rings and activated by heat of up to 200° C. to remove CO₂, and subsequently reduced in a 15-25% H₂ stream.

These categories of oxygen sorbent materials are either dispersed into high-surface area supports or made in highly porous form to increase oxygen adsorption/absorption kinetics and oxygen sorption capacity. A shortcoming of high surface area materials, however, is that they generally cannot sustain high processing temperatures. At high temperatures most conventional sorbent materials will sinter, which collapses the required high surface area supports into an unusable consolidated bulk. Thus, as mentioned above, the temperature range of use of those materials is limited to between room temperature and around 200° C. Since the functionality of oxygen sorption is preserved at relatively low temperature, running chemical reactions with sorbed oxygen is usually out of question. Hence, the oxygen sorbents cannot be applied readily to real-time chemical reactions, where the sorbent has already taken up some quantity of oxygen.

Moreover, with regard to the sorbents, which can function at higher temperatures above about 250° C., most of the oxygen sorption occurs as a result of surface interaction with gaseous oxygen. This oxidation occurs quickly on the surface of these materials, but rather slowly in bulk form. This kind of mechanism of substrate-surface absorption limits the overall oxygen sorption capacity. Up to now a need has existed for oxygen sorbents that can employ not only surface sorption, but also the bulk of the carrier material as an oxygen storage medium. A bulk sorbent possesses greater oxygen sorbing capacity for purification of a gas stream or for preserving an oxygen-free environment in an enclosed system. The present invention satisfies this need.

Among the various applications where the present sorbent material may be useful, a particular example may be found in the opto-electronic industry. In recent decades, organic, polymer-based devices such as optical planar devices, optical storage device, thermal optical switches and optical modulators have been extensively studied because of their optical performance, ease of manufacture and processing, and relative low cost for materials. For instance, high-speed modulators for telecommunication transmission have used guest-host organic materials with high electro-optic (EO) coefficients. These materials consist primarily of an electro-optic chromophore (guest), which is incorporated into a polymer matrix (host). Great progress has been made in terms of optical performance of these devices. Over the past ten years, organic EO materials have demonstrated numerous advances and improvements in technology. A great concern has arisen, however, about the reliability of polymer-based devices for use in the optical pathway. The reliability of EO chromophores has unfortunately prevented these organic material-based devices from becoming commercially successful. One of the most troublesome reliability issues is the long-term photostability of the EO chromophore in the polymer matrix.

The stability of EO chromophores in polymer hosts at various wavelengths is a great concern. Due to the nature of the EO chromophore molecules, exposure for extended periods to high-intensity ultra-violet or laser light in the presence of O₂ or H₂O will compromise optical polymers. When the EO material is formed into a waveguide and exposed to moderate intensities of near infrared light (several milliwatts), the EO chromophore can react photochemically to form a new compound, which is no longer EO-active. Over time this eventually and irreversibly decreases the performance of the modulator.

Polymer materials are also susceptible to degradation caused by exposure to oxygen and other contaminants. Optical polymers will react with gases in the environment, especially with oxygen through photo-oxidation. In particular, polymer degradation can affect the function of laser packages in the opto-electronic devices. The oxidation reaction damages the transmission surface of the polymer material, or the interface of a device and an optical fiber. In the packaging of optical devices, oxygen, as well as organic vapors and water, must be removed to ensure the extended service life of the devices. Polymer waveguides can absorb water, which delaminate the material, cause higher absorption and loss of signal wavelengths, and degrade mechanical properties in the waveguide and at the fiber-waveguide interface (known conventionally as a pig-tail interface). Moreover, even inorganic devices can suffer from oxygen-induced break down since they may still incorporate degradable components, such as optical adhesives or refractive index gels in the gaps between splices and other joints.

Studies have shown that the photostability of EO materials can be improved dramatically by controlling the amount of oxygen that comes in contact with the material. In fact, these studies have concluded that the presence of atmospheric oxygen greatly decreases the photostability of EO chromophores. If oxygen could be completely removed, or at least reduced significantly (<1 ppm to levels of 1 ppt), then the stability of devices using these materials could be greatly enhanced. Hence, a need exists for an effective oxygen-free packaging process.

In addition, oxygen in the enclosure of an opto-electronic device can form water when combined with hydrogen, which may be present in the enclosure atmosphere. The hydrogen may be present as a contaminant in the gas filling the enclosure or may out-gas from as the temperature of the enclosure increases. As a side effect, inherent from the packaging process, moisture can become physically trapped in a package. Water can cause electrical shorts, corrosion, or electro-migration in the electrical circuits contained in the device. During the manufacturing process of electronic or opto-electronic packages, care is taken to minimize the amount of organic material within the enclosed container. For instance, a suitable cleaning agent such as isopropyl alcohol may be applied to remove residues from the manufacturing process, such as solder flux. These efforts, however, are not necessarily successful in removing contaminants or preventing impurities from appearing. Hence, a getter material that can additionally remove water or organic vapors would also be beneficial.

### SUMMARY OF THE INVENTION

The present invention provides, in part, a family of oxygen-sorbent materials with high oxygen sorbing capacity and can operate over a wide range of temperatures, from about −40° C. or ambient room temperature (˜20° C.) to up to about 800-1200° C. The sorbents have a large oxygen sorption capacity, as well as potential for water or organic vapors, and can be employed where oxygen-free environments are required, such as in the packaging of electro-optical or laser components made from polymer or semiconductor materials. The sorbent material, it is believed, binds oxygen molecules by means of bulk-effect transport processes, in contrast to common surface sorption, as well as surface interaction. Thus, high temperatures have minimal effect on the present materials. This phenomenon provides greater oxygen storage capacity than most conventional sorbents of comparable volume or quantity. The absorption kinetics of the present sorbent materials can be tailored to work with particular applications as needed. Additionally, one can regenerate the sorbent material in-situ, whereas one may not be able do so with conventional materials. The present oxygen sorbent material can work in noxious environments, in which toxic elements, such as S, Hg, As, etc., may poison conventional catalysts.

According to the present invention, the oxygen sorbent materials are characterized as mixed-oxide carriers having either a predominant cerium oxide or a cerium oxide and zirconium oxide composition with other metal oxide additives. The cerium oxide content ranges from about 1% to about 99% by weight, the zirconium oxide content ranges from 0% to about 99% by weight, and other metal oxides (RₓO_{y}) content ranges from 0% to about 25% by weight, with x and y being integers. Preferably, cerium oxide ranges from about 20% to 80%, and the zirconium oxide ranges from about 20% to 80%. The mixed-oxide carrier has high surface area and nanometer-sized crystals. Optionally the carrier of mixed-oxide material may have, at least one of the following transition metals: Fe, Co, Ni, Cu, Ru, Pd, Rh, Pt, Ir, Os, and either oxides or mixtures thereof in catalytic amounts of 0.01 wt. % to about 10 wt. % deposited on its surface. In preferred embodiments the transition metals content is about 0.05-1 wt %.

The present invention also includes a method for preparing the oxygen-sorbent materials. According to the method, one prepares a mixed-oxide solution. Precipitate metal hydroxide from mixed salts with a concentrated base or mixed bases, wherein a reverse strike technique is employed, wherein the mixed-oxide solution is added into the base instead the reverse as usual. Then, collect the hydroxide precipitate and wash it with a liquid-phase solvent. Calcinate the hydroxide precipitate to the mixed oxide in flowing air. Impregnate the transition metal oxides on and in the mixed oxide powder of predominant cerium oxide and/or zirconium oxide composition. Activate the sorbent material in a reductive gas stream at high temperature. The present method can produce a single-phase CeO₂—ZeO₂ mixed-oxide matrix containing up to about 95 mole % ceria. The cerium and zirconium oxides mix on an atomic scale in a metastable state.

In another aspect, the present invention provides a getter component incorporating an iteration of a sorbent material, like that described in the foregoing text, and photonic devices, packages, or opto-electronic systems that including such a getter. The getter meets the need for an efficient, space-saving, high-capacity material for absorbing gaseous oxygen in opto-electronic devices. Relative to their volume, these materials have a large oxygen sorbing capacity in either a gas-stream or an enclosed system over a wide temperature range. The getter can remove trace amounts of oxygen and other contaminants from either a gas-stream or a closed system. The material can lower equilibrium oxygen concentrations to levels below 1 part per trillion (ppt) from, preferably, about −40° C. to up to about 500° C. or 550° C. This quality of sorption is very useful to absorb residual oxygen in hermetic packages during the manufacturing process of photonic devices. The getter material can operate at temperatures found in opto-electronic devices, typically about −40° C. to 70° C. The getter works by bulk material interaction with oxygen; thus, the oxygen sorbing material has the capacity to absorb additional oxygen, which may seep through hermetic seals during the lifetime of the devices. Unlike conventional getter materials, which are dependent surface area, the absorption capability of the present getter is less likely be exhausted completely if exposed accidentally to air.

For a composite getter material that can remove water or other harmful organic vapors (e.g., out-gases from polymeric materials), which can also contaminate the hermetically sealed packaging during operation, certain additives may be incorporated with the oxygen getter. The additives may include an inorganic binder and components chosen from the group including MCM-22, -24, -30, -41, zeolite type A, X, Y, L, ZSM-5, mordenite, cloverite, porous silica, porous borosilicate, activated carbon, activated alumina, porous alumina, and mixtures thereof.

The present invention relates to a device or a hermetically sealed opto-electronic package. The device or package comprises an enclosure, preferably sealed, in which there is an atmosphere and a component that is adversely affected by the presence of gaseous oxygen or other impurities in the atmosphere. Also included is a getter material comprising a mixed-oxide material composed by weight of about 20% to about 95% Ce₂O₃, about 5% to about 80% ZrO₂, and 0% to about 25% RₓO_{y}, wherein RₓO_{y} is another metal oxide, and x and y are integers; and at least one of the following transition metals: Fe, Co, Ni, Cu, Ru, Pd, Rh, Pt, Ir, Os, or their oxides or mixtures thereof in catalytic amount, on a surface of said mixed oxide material. A getter-housing may be in the enclosure.

In another aspect, the present invention pertains to a method to provide a virtually O₂-free atmosphere in an opto-electronic device package. The method comprises several steps. Provide a photonic device, a housing, and a getter material as described herein. Then, enclose the photonic device and the getter within the housing, and remove oxygen, and other contaminant vapors from the opto-electronic component using the getter material.

In other aspects, the invention relates to a method for making a photonic getter component and/or packaging an opto-electronic device. The method comprises first preparing a mixture of mixed-oxide compounds. Then, precipitate a mixed metal hydroxide with a concentrated base solution of mixed bases, from the mixed-oxide mixture. Collect and wash the hydroxide precipitate with a liquid-phase solvent. Impregnate mixed oxide powder with metals or metal oxides. Shape the hydroxide precipitate into a form. Calcinate the hydroxide precipitate in flowing air, and activate the hydroxide precipitate.

Additional features and advantages of the present invention will be described in detail below. The foregoing general description and the following detailed description and examples are merely representative of the invention, and are intended to provide an overview for understanding the invention.

### BRIEF DESCRIPTION OF THE DRAWINGS

FIG. 1 is a conventional phase diagram of the CeO₂—ZrO₂ system, adapted from Ernest M. Levin, Phase Diagrams for Ceramists, p.66, American Ceramic Society, 1956. The phase diagram helps to illustrate an aspect of the present invention, that is, the ability to achieve a metastable, single-phase, atomic mixture of CeO₂ and ZrO₂ of up to about 90-95 mole % CeO₂.

FIG. 2 is a cut-away, side view of a schematic of a laser device enclosure incorporating a getter.

FIG. 3 depicts the relative degree of photo-bleaching of an electro-optical chromophore in a polymer host exposed to 100 mW at the end of a single mode fiber at 1550 nm. The first 10,000 minutes shows the stability of the material in an environment of a 100% nitrogen atmosphere controlled for oxygen. Oxygen has a dramatic degrading effect on the material's photostability after 10,000 minutes, when the sample is exposed to ambient air.

### DETAILED DESCRIPTION OF THE INVENTION

The presence of gaseous oxygen, in addition to other contaminants, can be detrimental to various chemical or manufacturing processes, as well as the structural or functional integrity of some kinds of materials or their uses. For instance, insert gas, i.e., nearly oxygen-free gas is used in many industrial applications, such as for purging, blanketing, and maintaining an inert atmosphere in material transport. Particularly in the preparation of high molecular weight polymers, for instance, free oxygen must be excluded as much as possible from feed gases employed for many catalytic polymerization processes.

Oxygen sorbents, which are currently available, employ CuO or cobalt oxide on a carrier substrate such as zeolite, or high-surface area silica. These kinds of materials, to reiterate, suffer from various restrictions. For example, they are limited in the range of temperatures in which they may operate or regenerate, or because of the surface-sorption, they cannot both sorb and store effectively large amounts of oxygen. As mentioned before, these kinds of materials sinter at relatively low temperatures. A regenerable sorbent in the form of a bulk-material that can both remove and store great amounts of oxygen from either a gas-stream or a closed system is needed.

In part, the present invention addresses these issues and provides other favorable attributes. The present sorbents have a large oxygen sorption capacity, thus a small volume of the material is effective, and can be employed in small volume enclosures where oxygen-free environments are required, such as in the packaging of electro-optical components made from polymer or semiconductor materials. The sorbent materials possess additional capacity to take up any additional oxygen that may seep through hermetical seals into an enclosed environment or container. After complete exhaustion or reduction of the oxygen sorbing materials, the oxygen sorption capacity per volume is several times—at least 1.5 times, preferably about 2-3 times—greater than conventional sorbents. The oxygen sorption capacity is about 10-15 ml/g. This phenomenon is in part due the way the sorbent material binds oxygen.

The function of conventional sorbent materials can be severely limited, if not destroyed, when the material is accidentally exposed to air, since these sorbents rely on surface adsorption. In contrast to common surface sorption or surface interaction, the sorbent material binds oxygen molecules by means of bulk-effect transport processes. Thus, high temperatures have minimal effect on the present materials. This phenomenon provides greater oxygen storage capacity than most conventional sorbents of comparable volume or quantity. The oxygen-sorbent materials can operate over a wide range of temperatures, from about −40° C. to up to about 800° C. or 1000° C. Preferable temperatures range from about ambient room temperature (˜20° C.) up to about 500° C. The absorption kinetics of the present sorbent materials can be tailored to work with particular applications as needed. Up to about 500° C., the bulk solid oxygen sorbents can lower equilibrium oxygen concentrations to below 1 part per trillion (1 ppt). Such a sorbent material can be particularly useful, for instance, as getters in devices which contain a component that is adversely affected by the presence of gaseous oxygen or other impurities. Additionally, one can regenerate the sorbent material in-situ, whereas one may not be able do so with conventional materials.

Moreover, since the present oxygen sorbent uses bulk-effect, diffusion kinetics, which can enable one to tailor the surface area by sintering the material, which reduces the available surface area. A lower surface area can better resist and reduce the immediate loss of absorption capacity if exposed to air. Hence, the present getter has a reduced sensitivity to air, while preserving its oxygen sorbing capacity and service life. These features permit simpler handling procedures and requirements during manufacture or work site assembly to protect from accidental exposure to air, than currently enjoyed.

According to the present invention, the oxygen sorbent materials are characterized as mixed-oxide carriers, that is, they include a catalyst disposed in and/or supported on a mixed-oxide solid solution carrier. Depending on the application, catalysts accelerate the sorption process. The sorbent materials have either a predominant cerium oxide (Ce₂O₃) or a cerium oxide and zirconium oxide (ZrO₂) composition with possibly other metal oxide additives. Zirconium oxide in the sorbent provides a matrix for fast oxygen ion transport, which facilitates the movement of oxygen in solid phase. In other words, ZrO₂ facilitates the effective use of Ce₂O₃ in bulk form as embedded in the carrier.

The cerium oxide content in the sorbent material ranges from about 1% to about 99% by weight, the zirconium oxide content ranges from 0% to about 99% by weight, and other metal oxides (RₓO_{y}) content ranges from 0% to about 25% by weight, with x and y being integers. In certain embodiments, the composition by weight may have about 20% to about 99% Ce₂O₃, about 1% to about 80% ZrO₂, and 5% to about 22% RₓO_{y}. The content of cerium oxide may also range from about 25% up to about 95% by weight. Preferably, cerium oxide ranges from about 20% to 80%, and the zirconium oxide ranges from about 20% to 80%. In some more preferred compositions, cerium oxide content is in the range of about 40% to about 85%. In the most preferred composition, the cerium oxide content is in the range of about 40% to about 75%. The content of zirconia is in the range of about 0% or 1-5% to about 80% by weight. The preferred zirconium oxide content is in the range of 10-20% to 80%. The most preferred zirconium oxide content is in the range of 40% to 80%, (e.g., ˜50-60 wt. %). The content of other additives is in the range of 0 to 20%. The mixed-oxide carrier has high surface area and nanometer-sized crystals.

In addition, the mixed-oxide material carrier may have transition metals and either oxides or mixtures thereof. Small amounts of about 0 or 0.01 wt. % to about 10 wt. % of metal catalysts may be disposed in and/or on a surface of the mixed oxide materials to accelerate the oxygen sorbing kinetics at room temperature. The catalysts include at least one of the following transition metals, such as Fe, Co, Ni, Cu, Ru, Pd, Rh, Pt, Ir, Os, or their oxides or mixtures thereof as a catalyst or activator. The content of catalyst is typically in the range of less than about 5% by weight. In a preferred composition, the catalyst content is below about 2%, and the most preferred composition of the catalysts is below 1% (e.g., about 0.05-1 wt %).

The preferred catalysts are among the precious metals, such as Pt, Pd, Ir, and Rh. The most preferred catalysts are Pt and Pd. Incorporation of platinum group metals in the basic oxygen sorbing materials can achieve two functions. First, during the activation or reduction of the metal oxide, the platinum group metals act as catalyst to lower the reduction temperature in the gas (e.g., hydrogen) flow. This helps to maintain the high dispersion of metal oxides, and resultant rapid oxygen-sorption kinetics during use. Platinum group metals on the surface of the solid solution catalyzes the redox reaction of equation (1) at fairly low temperatures. The temperature can be reduced to nearly ˜200-400° C. depending on the type of reductants applied. Second, during use, platinum metal catalysts promote the dissociation of molecular oxygen, which accelerates the oxygen sorbing kinetics even at room temperature by promoting oxidation. The dissociated oxygen converts quickly to oxygen anions, which transfer to the pre-reduced mixed solid solution and fill oxygen vacant sites at room temperature. Hence, because of these properties, the catalyzed mixed oxide solid solutions behave as excellent oxygen sorbents at room temperature after reduction.

Optionally, other additives such as transition (e.g., Group IIIB) or rare earth oxides (e.g., Y₂O₃, Sc₂O₃, Nd₂O₃, or Sm₂O₃) may be present in the sorbents. In particular, yttrium oxide will improve the oxygen conductivity at room temperature by increasing oxygen vacancy sites in the mixed-oxide solid solution. In some compositions, the content of other additives may be present in amounts of up to about 10 or 15% by weight, preferably about 5% to 15%, and 5% to 10% in some of the more preferred compositions.

As said before, the sorbent material comprises cerium oxide-based mixed-oxide solid solutions. Cerium oxide has a high affinity for binding gaseous oxygen when coupled with zirconium oxide. Because of their propensity for reduction-oxidation reactions, mixed-solid solutions based on cerium oxide have high oxygen storage capacity. The oxidation state of cerium in the mixed-solid solution strongly depends on the oxygen concentration present in the surrounding environment. This phenomenon is expressed according to the following reaction:

Ce₂O₃+O₂=2CeO₂ (1)

Cerium (III) oxide tends to be unstable, while data indicates that cerium (IV) oxide is extremely stable. This phenomenon, thus, promotes the binding of oxygen. The redox reaction of cerium oxide provides oxygen sorption capacity at various temperatures. Thermodynamic calculations of the reaction of equation (1) are summarized in the following table.

| Temperature (° C.) | ΔH (kJ/mole) | ΔS (J/mole) | ΔG (kJ/mole) | Equilibrium P_{O2} (atm) |
|---|---|---|---|---|
| 0 | −182.095 | −61.082 | −165.410 | 2.34 × 10⁻³² |
| 100 | −182.508 | −62.372 | −159.234 | 5.13 × 10⁻²³ |
| 200 | −182.912 | −63.332 | −152.947 | 1.30 × 10⁻¹⁷ |
| 300 | −183.319 | −64.111 | −146.573 | 4.38 × 10⁻¹⁴ |
| 400 | −183.732 | −64.776 | −140.128 | 1.34 × 10⁻¹¹ |
| 500 | −184.155 | −65.362 | −133.621 | 9.39 × 10⁻¹⁰ |
| 600 | −184.558 | −65.889 | −127.058 | 2.36 × 10⁻⁸ |
| 700 | −185.033 | −66.370 | −120.445 | 3.00 × 10⁻⁷ |
| 800 | −185.488 | −66.815 | −113.775 | 2.8 × 10⁻⁶ |
| 900 | −185.955 | −67.231 | −107.082 | 1.70 × 10⁻⁵ |
| 1000 | −186.433 | −67.622 | −100.339 | 6.26 × 10⁻⁵ |

The oxygen concentration at equilibrium is very low over a wide range of temperatures.

Oxygen sorption in pure cerium oxide is impeded by rather slow or limited oxidation kinetics. Zirconium oxide provides a matrix for fast oxygen conduction. Hence, zirconium oxide can be incorporated into cerium oxide to form a mixed solid solution, which helps to increase oxidation kinetics. Zirconium oxide serves at least three basic functions in the present sorbent compositions. First, zirconium oxide provides improved oxygen transport or conductivity through the bulk sorbent material and enables Ce₂O₃, in the carrier away from the surface, to function effectively as sorbents. Second, zirconium oxide affords increased high-temperature stability to the material. Third, zirconium oxide reduces the crystal size of the material and increases the overall surface area. (Cerium oxide has a relatively low surface area) The surface area of the mixed-oxide material may range from about 0.1 m²/g to 150-160 m²/g, usually around about 50-100 m²/g. With a crystal size of a few nanometers, the short diffusion distance of lattice oxygen from bulk material to the surface of the material can increase the reduction kinetics, as well as oxygen sorbing kinetics. By increasing oxygen vacancy sites, introduction of other additives such as yttrium oxide will further improve oxygen conductivity in the solid solution.

As characterized by X-ray powder diffraction, the crystal size of the above mixed oxides is in the range of about 1 nm to about 100 microns. A preferred crystal size of the mixed oxides strongly depends on the application. In an application where low residue oxygen and low temperature are required, small crystal sized mixed oxides are preferred, in the range of about 4 nm to about 100 nm. For an application at high temperatures, any crystal size will be adequate thanks to an affinity of the present compositions for high oxygen ion transport at high temperatures. For an application where the material may be exposed to air during the handling, a large crystal size is preferred to reduce the air sensitivity after activation.

An activation process is required to reduce the sorbent before being used in application. The reductants may include hydrogen, carbon monoxide and hydrocarbon vapors. The preferred reductant is hydrogen. The reduction (activation) temperature is in the range of 200° C. or 300° C. to 1000° C. Preferably the activation temperature is 400° C. to 600° C. To regenerate the sorbent material, one may similarly flush the mixed-oxide carrier with a hydrogen or carbon monoxide stream. The present sorbent materials can be regenerated on site in the application or device. An advantage of this feature is that the material is more adaptable to its environment.

The thermal stability of inorganic compounds can be defined as the stability of the surface area when material is aged at high temperature. For many applications, particularly catalysis, high surface area and highly stable materials are required by end users. In accordance with the present invention, cerium and zirconium mixed oxides and solid solutions are produced having improved thermal stability. The cerium oxide and zirconim oxide and mixtures thereof have improved thermal stability and greater oxygen sorbing bulk capacity than conventional oxygen sorbent materials. The material is stable up to about 1000° C. or about 1200° C. Thus, the sorbent can operate in a wide temperature range from about 0° C. to about 1200° C., preferably in the range from about ambient room temperature (˜20° C.) to about 800-1000° C., most preferably from about 25° C. to about 200-250° C., or up to about 500° C. Due to in-part the wider operation temperature range, the present cerium-oxide based material can remove higher concentrations of oxygen, greater than 1 vol. %, unlike commercially available sorbent materials.

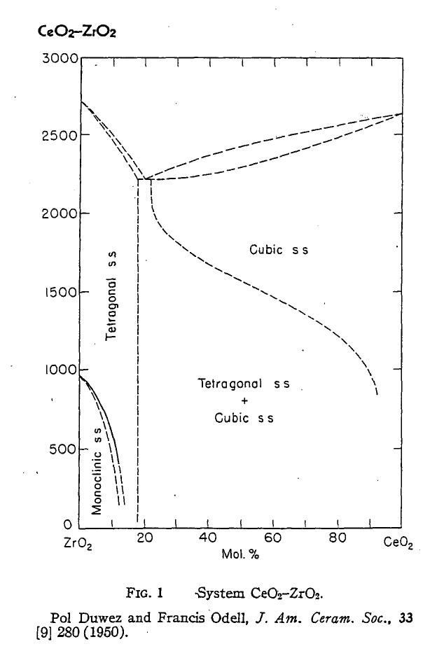

The solubility of cerium oxide in a zirconium oxide matrix has been limited to about 17 mole percent. When the cerium oxide content is higher than the solubility limit, as indicated in the phase diagram, FIG. 1, the mixed oxides will separate into two phases: pure cerium oxide and about 17% ceria-doped zirconia. In other words, any further addition of CeO₂ into the mixture will not be incorporated, but rather will separate out as pure CeO₂. A process for producing cerium oxides, zirconium oxides, and mixed oxides or solid solutions thereof is described in U.S. Pat. No. 5,723,101, the content of which is incorporated herein by reference. The process according to the '101 patent, however, produces a material that has much lower oxygen storage capacity or oxygen absorption capacity because of the separated phase. The present invention overcomes the general limitation of the conventional system. The present method enables one to manufacture, in a powder form, mixed cerium and zirconium oxides solution of greater than 17% solubility. The present mixed-oxide sorbent material is of a single-phase, with a ceria content up to about 90-95 mole percent. Preferably, CeO₂ content according to the present invention ranges from about 50-60% up to about 80% for temperatures of up to about 1200° C. The single phase is very important for oxygen absorption capacity, as well oxygen conductivity.

In the present invention, we have come to understand the phase separation mechanism and have discovered and demonstrated a method for preventing the phase separation. It was discovered that cerium hydroxide as precipitated is readily dehydrated and crystallized to cerium oxide upon heating at ˜70° C., while precipitated zirconium hydroxide dehydrates at temperature over 150° C. The crystallization temperature for zirconium oxide is even higher at 426° C. The huge difference in crystallization temperature forces cerium oxide crystallizes first, therefore, forms separated phases. With the present inventive process, hydroxide groups in the mixed precipitates were at least replaced partially with ethoxide groups upon washing with ethanol. In the calcination process, the partially ethoxidized precipitates are decomposed and oxidized in the same temperature range between about 200-250° C. This process allows cerium and zirconium oxides to mix on an atomic scale, which produces true single-phase mixed oxides.

The activity of oxygen sorbents is strongly related to the manufacturing process of the materials. Different manufacturing processes can produce mixed-oxide carriers with different properties. Mixed-oxide materials may be manufactured by techniques such precipitation, co-precipitation, sol-gel, high temperature solid phase diffusion with mixture of respective oxides, thermal decomposition of mixed salts, i.e., nitrate, carbonates, chlorides, oxalates, etc. Accordingly, another aspect of the present invention is a method for preparing the sorbent materials.

As outlined briefly before, the method includes several steps. First one prepares the mixed-oxide carrier or support. One prepares a mixture in aqueous medium of at least a soluble cerium compound and at least a soluble zirconium compound. The mixture can be obtained from either sold compounds, which are dissolved in water, or directly from aqueous solutions of these compounds, followed by mixing, in any order of the defined solutions. Suitable water-soluble cerium compounds include cerium (III) salts, like nitrates or chlorides, or cerium (IV) salts, such as ceric ammonium nitrate, for instance. Suitable zirconium salts include zirconium sulfate, zirconyl nitrate, or zirconyl chloride, for example.

Once the mixture is prepared, a “reverse strike” technique is employed, wherein the cerium/zirconium salt solution is added to a base to precipitate hydroxides. Ordinarily, the base is incorporated into the salt in a so-called “regular strike.” The order and way for the salts and base to interact has important consequences to particle surface area, phase separation and material stability. As will be further described in the examples, which follow, a reverse strike approach can eliminate phase separation at high temperatures for greater material stability.

The base used can be an ammonia solution or alkaline hydroxide solution (e.g., sodium, potassium, etc.). The ammonia solution is preferred to avoid incorporating alkaline (sodium or potassium) species into the precipitate. The base concentration ranges from about 1 M/L to about 16 M/L, with a preferred concentration between about 4 M/L to about 8 M/L.

Once formed, the hydroxide precipitate is collected and washed with a liquid-phase solvent, such as anhydrous alcohol or other dehydrating agents, for 2 to 6 cycles. (Examples of agents include methanol, ethanol, propanol, ketones, acetone, ethyl-acetate.) In particular preferred examples, the solvent used is ethanol. After drying, the hydroxide precipitate is calcinated to a mixed oxide material-powder in flowing air. The calcinating step occurs at a temperature between about 250° C. or 300° C. to about 1000° C., and preferably at a temperature between about 400° C. to about 500° C. or 600° C., for about 1-10 hours. Best calcinating results may be achieved at about 4 hours. One may impregnate transition or precious metal oxides on and/or in the mixed-oxide powder of the carrier composition, as catalysts to accelerate the oxygen absorbing kinetics. Hence, two embodiments of the present sorbent, with or without metal catalysts, can be made. The activating step is by means of a reduction process with hydrogen at about 400° C. for about 4 hours.

The following provides additional detailed examples of manufacturing processes of the oxygen sorbents, and which further describe the present invention.

### EXAMPLE I

According to the present invention, a “reverse strike” co-precipitate process is applied to the production of mixed oxides, although many other above described methods are useful.

In general, weighed cerium nitrate, zirconium nitrate and yttrium nitrate solution with a certain composition are mixed and dissolved in water to form a clear aqueous solution. The solution is slowly added into an ammonium hydroxide solution with a concentration ranging from ˜1 M/L to ˜8 M/L. The amount of ammonium hydroxide is present in excess of that required by stoichiometry, so that the pH value of the resulting slurry maintains above at least 12. The overwhelming amount of the base ensures all cations are precipitated at once without separation.

After filtration, the collected hydroxide wet cake is fully re-dispersed in anhydrous ethanol. After dispersion, the precipitate is collected by centrifugation and is then redispersed in fresh ethanol. After several cycles of the washing processes, the collected precipitate is dried in an oven at 95° C. over night.

The dried precipitate is then calcined at 500° C. for 4 hours in flowing air to form the desired mixed oxides. The resultant fine powder is characterized by X-ray diffraction and is confirmed to be a single-phase crystalline material.

A pre-weighed hydrogen platinic acid is dissolved in water to form aqueous solution. The mixed oxide material is impregnated with the solution by incipient wetness impregnation technique. After impregnation with platinic acid, the mixed oxide is dried in an oven and is calcined at 400° C. in flowing air and subsequently in flowing hydrogen at the same temperature for 4 hours as an activation process. The resulted material is ready to be used as a sorbent for oxygen.

### EXAMPLE II

To prepare the carrier or support medium, about 108.6 g. cerium nitrate and about 67.3 g. of zirconyl nitrate were mixed and dissolved in about 500 ml water to form an aqueous solution after being stirred overnight. The resulting solution was added into 500 ml 4.0M ammonia solution in a controlled fashion, drop-by-drop. A purplish precipitate was observed. After the reaction was completed, the precipitate slurry was aged for over two hours and then filtered to remove the aqueous solution. The collected wet cake was transferred into an anhydrous ethanol. After dispersion, the precipitate slurry was centrifuged for about 20-30 minutes at 3000 rpm. After desiccation of the alcohol, the precipitates were redispersed in anhydrous ethanol. After washing with ethanol for about 5-10 times, preferably 6 times, the collected precipitates were dried in an over at about 95° C. for overnight. The resulted precipitates were crushed into powder. The powder was calcined in air at about 500° C. for about 4 hours. The calcined power was designated as CSZ-1. The particular solids have a surface area measured at 102.6 M²/g with nitrogen adsorption according to the Brunauer, Emmett and Teller Method (BET).

### EXAMPLE III

### Comparative Example Using “Regular Strike”

The same amounts of chemical reagents as used in Example I, were dissolved into an aqueous solution. Instead of adding the salt solution into the ammonia, the diluted ammonia solution (4M, 500 ml) was added into the salt solution in controlled fashion, drop by drop. The resulting precipitates were collected and washed with the identical process described in Example I. The sample attained was denoted as CSZ-2. The BET surface area was at 68.3M²/g.

### EXAMPLE IV

In another example, a mixture of about 43.5 g. cerium nitrate and about 107.6 g zirconyl nitrate was dissolved in about 500 ml water. The resulting solution was added into ammonia solution drop by drop and followed all the procedures as described above. The calcined sample was designated to CSZ-3. The BET surface area was at 116.0 M²/g.

### EXAMPLE V

About 1 g of 10% (Pt weight %) H₂PtCl₆ was diluted into a glass vial that had about 2.3 g of water. To the vial, about 10 g. of the calcinated powder sample from Example III was added. The platinum solution impregnated into the powder by incipient wetness technique. The resultant powder was dried at about 95° C. overnight and was calcined at about 500° C. for about 4 hours. The catalyst/sorbent is designated as CSZ-3-Pt-1. The surface area of the obtained catalyst is essentially the same as the precursor oxides.

### EXAMPLE VI

About 0.1 g of CSZ-1 from Example II was charged into a mini-reactor on Zeton Altamira-200 for temperature programmed reduction and oxidation. After drying at 350° C. in flowing 10% O2/He gas flow and subsequently cooling to room temperature, the sample was heated up at a ramp of 10° C./min in 10% H2/Ar. The effluent gas was analyzed for hydrogen consumption with the attached thermal conductivity detector (TCD) as the temperature progressed to 1000° C. The total hydrogen consumption was integrated on TCD signal and calibrated as the volume of hydrogen under standard temperature and pressure (STP). The hydrogen consumption was calculated to be at 39.04 ml/g at 1000° C. that represented that 97.5% of cerium oxide in the CSZ-1 material had been reduced to Ce₂O₃ at the temperature. The sample was cooled in the flowing 10% H2/Ar to room temperature. As the gas flow switched to 10% O₂/He, the sample temperature was immediately raised up to 85° C. due to very rapid oxidation of the pre-reduced material. After fully oxidation with 10% O₂/He at room temperature, the sample weight was rechecked to be essentially the same as the charged. The oxygen absorbed were calculated to be 18.5 ml/g (STP) of CSZ-1.

### EXAMPLE VII

The CSZ-1 material was heated up to 900° C. in air for 24 hours as designated as CSZ-1-900. The CSZ-1-900 sample was tested according to procedure described in Example VI. The hydrogen consumption was confirmed to be 35.44 ml/g at 1000° C. that denotes 93.5% CeO2 has been reduced to Ce2O3. After the sample cooled to room temperature, the oxygen pickup was determined to be 17.7 ml/g (STP). The results indicated that the oxygen sorbing material withstood high temperature aging up to 900° C.

### EXAMPLE VIII

The CSZ-3-Pt-1 material in Example V was treated according the procedure described in Example V. The hydrogen consumption was determined to be 38.02 ml/g (STP) at 1000° C. The data indicated that total hydrogen consumption was almost no change compared to the sample without platinum loading. However, the material reduction temperature was dramatically reduced to a peak at 280° C. With the reduction at 300° C., 74% of oxygen storage capacity was generated, indicated that the catalyzed material is much easier to be used as an oxygen absorber.

The present cerium oxide-based materials are both resilient and cost effective to operate. An advantage of the present getter materials over commercial sorbents based on copper catalysts (e.g., BASF catalyst R-3-11G) is that the mixed-oxide sorbents can withstand operating temperatures that exceed about 250° C. better than materials which use CuO dispersed on high surface areas suffer a loss of performance. Tests of photonic devices under 85° C./85% humidity conditions, also demonstrate that cerium-oxide based getters are more resistant and stable. Moreover, the present oxygen sorbent material can work in noxious environments, in which toxic elements may poison conventional catalysts. Cerium does not suffer from the potential of being poisoned by compounds containing heavy metals (e.g., antimony, arsenic, lead, mercury, phosphorus, or vanadium), or sulfur compounds (e.g., H₂S, COS and mercaptans). As these impurities accumulate in the catalyst, the sorbent gradually looses capacity for its intended purpose of removing oxygen, thereby sacrificing the useful life. Such a loss of capacity is not economical or cost-effective for removing impurities.

To reiterate, the present invention has several aspects. First the invention, in part, relates to a regenerable sorbent for removing trace amounts of oxygen from either a gas-stream or a closed system. The sorbent comprises: a mixed-oxide material composed by weight of about 1% to about 99% Ce₂O₃, about 1% to about 99% ZrO₂, and 0% to about 25% RₓO_{y}, wherein RₓO_{y} is another metal oxide, and x and y are integers; and at least one of the following transition metals: Fe, Co, Ni, Cu, Ru, Pd, Rh, Pt, Ir, Os, or their oxides or mixtures thereof in catalytic amount of 0% to about 10%, on a surface of said mixed oxide material.

The cerium oxide content may ranges from about 20% to about 95% by weight, and the zirconium oxide content is 20-80% by weight. Preferably, the zirconium oxide content is about 40-50% by weight. The mixed-oxide material is of a single-phase metastable matrix. The RₓO_{y} is a transition metal or rare earth metal oxide. The transition metals and oxides thereof are of either Pd, Rh, Pt, Ir or a combination thereof in an amount of about 0.01 to 5% by weight. The mixed oxide material has a surface area ranging from about 0.1 m²/g to about 150 m²/g, and a crystal size ranging from about 1 nm to about 100 microns, preferably ranging from about 4 nm to 90 microns. The sorbent according to certain embodiments can operate in a wide range of temperatures, from −40° C. up to about 1200° C., but more commonly from about 0° C. or about ambient room temperature (˜20° C.) to about 1000° C.

The sorbent material has an oxygen sorption capacity of at least two (2) times greater than conventional sorbents per volume after complete reduction of the material, and possesses additional capacity to take up any oxygen that may seep through hermetical seals into an enclosed environment or container making it useful for packaging applications. The oxygen capacity is about 10-15 ml per gram. The sorbent can operate in noxious environments, which would otherwise poison conventional catalysts.

In another aspect the invention pertains to a method or process of preparing an oxygen sorbent, such as described herein. The method comprises: a) preparing a mixture of mixed-oxide compounds; b) precipitating a mixed metal hydroxide with a concentrated base solution of mixed bases, from said mixed-oxide mixture by adding said mixed-oxide mixture into said base solution; c) collecting said hydroxide precipitate and washing with a liquid-phase solvent; d) calcinating said hydroxide precipitate to a mixed oxide material in flowing air.

The method may further comprise impregnating metal or metal oxides on and in the mixed-oxide material, and activating the hydroxide precipitate or mixed oxide material. The activating step is a reduction of the hydroxide precipitate or mixed-oxide material. The activating step is by means of reduction at about 400° C. for about 4 hours. The activating step uses hydrogen, carbon monoxide, hydrocarbon vapor, or other reducing agents. The calcination step occurs at a temperature between about 250° C. to about 600° C., preferably at a temperature between about 400° C. to about 500° C., for about 1-10 hours, preferably for about 4 hours.

A single-phase mixed oxide matrix of ceria and zirconia is produced, having a ceria content of up to about 95 mole %. Preferably, the ceria content in the mixed-oxide material is about 50-80 mole %. Alternatively, the single-phase material is of a metastable mixed-oxide matrix. In the method the hydroxide precipitate is washed for 2 to 6 cycles. The mixed oxide material can be in the form of a powder. The mixture of mixed-oxide compounds includes an aqueous medium of at least a soluble cerium compound and at least a soluble zirconium compound. The mixed-oxide compounds include soluble cerium (III) or cerium (IV) salts. The mixed-oxide compounds include soluble zirconium salts. The mixed-oxide mixture is incorporated into the base solution. The base is ammonium hydroxide. The base concentration ranges from about 1 M/L to 16 M/L, or preferably the base concentration ranges from about 4M/L to 8 M/L. The liquid-phase solvent is a dehydrating agent, such as an alcohol (e.g., ethanol).

An embodiment of the sorbent material described above can be adapted for use as getters. The getter material includes mixing oxygen storage materials coupled with a catalyst, and having purified zeolite and other absorbents. A single getter body attached to an inside surface of the device housing should be effective to absorb any oxygen and/or immobilize water or organic impurities, which may be present. For certain applications, the sorbent or getter material is particularly beneficial.

For instance, it is desirable to use organic or polymer-based opto-electronic devices because the materials are more cost effective and devices are easier to make. Often, however, a device using organic or polymer materials needs to be packaged in either a vacuum or an inert atmosphere with an oxygen getter material. A most prevalent species, oxygen affects detrimentally organic or polymer components in photonic devices. Oxygen can cause photo-degradation of the polymer materials in additional to other problems. Devices in opto-electonic telecommunication modules that can be subject to oxygen-caused degradation may include, for instance, modulators, wavelength multiplexers or demultiplexers, couplers, optical switches, organic or polymer light emitting diodes (OLED). As mentioned above, a getter composed of the present sorbent material can absorb any residual oxygen left in the package from manufacturing. Or, the getter can efficiently absorb any oxygen, water or organic vapors, which may seep into the enclosed package during its service life, before the gas can diffuse into the material and contribute to photo-oxidation.

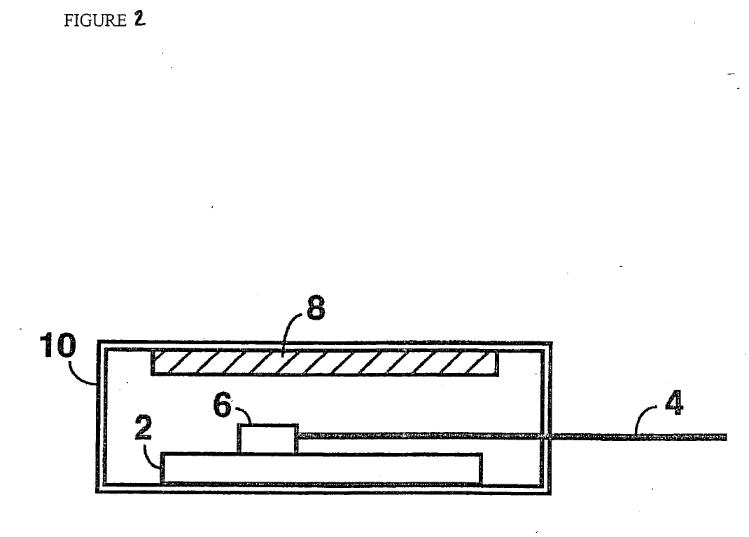

FIG. 2 shows a schematic cut-away view of a getter positioned within the housing 10 for a photonic device. The photonic device may include polymer-based components, such as optical planar devices, optical storage device, optical connecting splice adhesives or gels, thermal optical switches and optical modulators, as well as amplifers and waveguide devices. The photonic device may contain a high power laser 6, such as a signal laser or a high power pump laser, affixed to a substrate 2, for an amplifier fiber. The electronic device and circuitry that are associated with the laser and typically contained in the housing are not shown. Typical practice in the case of a pump laser is to couple the laser to a waveguide amplifier fiber by coupling means which conduct light through a sealed aperture in the enclosure wall. The means for coupling the laser light to a receiving device or a waveguide fiber is shown as waveguide fiber 4. Other coupling means such as lenses or integrated waveguide devices may be employed as couplers. Laser light may be coupled to a receiving device or a waveguide located within the enclosure. As an alternative, the coupling means may allow laser light to pass out of the enclosure through a sealed aperture.

As illustrated in FIG. 2, the inventive getter body 8 is shown as a slab attached to the top inside surface of the hermetically sealed enclosure 10. The getter 8 may be adhesively attached, or metallized and soldered, or held in a permeable container or housing. A porous getter-housing—not shown—may also be incorporated. Also getter bodies may be fixedly attached to any or all of the inside surfaces of the enclosure. The getter material can prevent damage to sensitive components, particularly organic components, in the light path of opto-electronic devices which are susceptible to photo-degradation when the laser light energy and gaseous oxygen interacting with the organic material. Because of the typically small inside volume of the housing, the getter should be relatively compact. A small volume of the present composite getter material can sorb efficiently large quantities of gaseous oxygen, water, and hydrocarbon or organic vapors in the packaging.

Water and organic or hydrocarbon vapors are other detrimental species that must be removed from within the packaging of optical devices, such as fiber laser packages or other micro-optic assemblies, so as to ensure the extended service life of the devices. As mentioned before, water and other organic vapors inflict harm to the performance of optical devices. Water vapor can react with organic polymers to degrade the optical and mechanical properties of the polymer molecules, as well as damage electronic components. It is highly desirable to maintain water vapor content below 5,000 ppm, and preferably, below 1,000 ppm.

In the past, people have tried various way of removing water and hydrocarbons. Their efforts, although successful to a degree, have not attacked one of the primary causes for the presence of water. If one were able to effective remove oxygen, the formation of water, it is believed, can be reduced. Given the oxygen sorbing capability of the present mixed-oxide sorbent material, a combination is provided. The present invention has a second embodiment. To help reduce the presence of water and/or hydrocarbon vapor and the likelihood of the oxygen reacting with hydrocarbons in the package, other adsorbents, such as zeolite or Vycor® glass, or high-surface area silica-alumina gel, will be incorporated preferably to the getter material.

By means of techniques such as ion exchange or impregnation, transition metal oxides can be dispersed on high surface area zeolite. Oxidation of the highly dispersed metal oxides functions to sorb oxygen. The transition metal oxides are selected from chromium oxides, manganese oxides, cobalt oxides and copper oxides. More preferred materials include cobalt and copper oxides. The metal oxide loading is typically in the range of about 5-25 wt %, with a preferred loading of about 10-15 wt %. The zeolite surfaces used in this application are chosen from A, X, Y, L, ZSM-5, mordenite, cloverite, etc. Preferred zeolites are X zeolite, which provides high surface area and many sites for ion exchange, thus increased loading of metal oxides with a high dispersion. The zeolite may also have platinum or paladium catalysts, which makes the metal oxides very good for oxygen remover in a contained environment. The high dispersion of metal oxides ensures high capacity for oxygen sorbing and fast kinetics for oxygen removal. The zeolite functions not only as a matrix for metal oxides, but also as an adsorbent for water and hydrocarbon vapors, as described in detail in co-assigned U.S. Pat. No. 5,696,785, the content of which is incorporated herein by reference.

Optionally, other inorganic adsorbents may be added for specific functions. For instance, to attain a greater capacity for absorbing hydrocarbons in environments where hydrocarbon vapor levels are high, porous glass (e.g., Vycor® by Corning Inc.) may be employed with the absorbent. With an inorganic binder additives may include porous silica, porous borosilicate, activated carbon, activated alumina, porous alumina.

According to the present invention, the oxygen sorbing materials are applied in the packaging of a polymer-based optical device after activation or reduction. To activate the materials, the sorbing materials are reduced, such as in a hydrogen or hydrocarbon gas stream, at an elevated temperature of about 300-500° C., preferably about 400-500° C. The oxygen sorbing mechanism results from an oxidation of the sorbing material by oxygen.

According to the present invention, the method of providing a virtually O₂-free atmosphere in an opto-electronic device package comprises several steps. First, provide a photonic device, a housing, and a getter material as described herein. In particular, the getter comprises a mixed-oxide material composed by weight of about 20% to about 95% Ce₂O₃, about 5% to about 80% ZrO₂, and 0% to about 25% RₓO_{y}, wherein RₓO_{y} is another metal oxide, and x and y are integers. The getter material may also contain at least one of the following transition metals: Fe, Co, Ni, Cu, Ru, Pd, Rh, Pt, Ir, Os, or their oxides or mixtures thereof in catalytic amount, on a surface of said mixed oxide material. Then, enclose said photonic device and said getter within said housing, and remove oxygen and other contaminant vapors from the opto-electronic component. The getter material may further comprise an inorganic binder and components chosen from the group including MCM of various sizes (e.g., 22, 41, etc.), zeolite type A, X, Y, L, ZSM-5, mordenite, cloverite, porous silica, porous borosilicate, activated carbon, activated alumina, porous alumina. The oxygen sorbing material may be formed into any shape using various forming process (e.g., extrusion, pelletizing, etc.). The shape of the material may include, for instance, the following: beads, pellets, granules, ribbons, slab, brick, ring, sheet or other bulk forms, which may be contained within a porous getter housing or enclosure.

Since the getter material has a high oxygen sorbing capacity per volume, which both saves space in the limited volume of the housing as well as is cost effective to use in a hermetically sealed opto-electronic package. The package comprises a sealed enclosure in which there is an atmosphere and a component that is adversely affected by the presence of gaseous oxygen or other impurities in said atmosphere, and a getter material like that described herein. The device preferably has a packaging or housing that may contain either a vacuum or an inert atmosphere, such as of nitrogen or argon gas. In such an environment, the useful lifetime of the getter may be conserved and a likelihood of breakdown reduced. Optionally, a getter-housing may be included within the enclosure.

Another issue to be aware of is the stability of materials. Polymer devices do not perform well over time in the optical telecommunication region of 1300-1320 nm wavelengths because of photo instability. A hypothesis of the reason for photo instability is the presence of singlet oxygen, which can be generated in the 1300-1320 nm wavelength region. Using the present getter material to remove oxygen from the device packaging can benefit fiber optic applications operating at ˜1300-1320 nm, as well as C-band wavelengths (i.e., ˜1525-1575 nm).

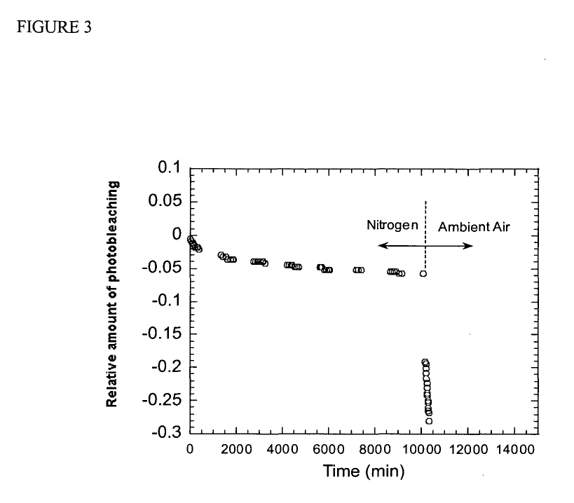

For instance, high-speed modulators that employ guest-host organic materials with high electro-optic (EO) coefficients are rapidly degraded. Oxygen effects the photostability of an EO chromophore in a polymer host when exposed to a high intensity telecommunication signal at 1550 nm. FIG. 3 shows the relative magnitude of photobleaching as a function of time of an EO chromophore. Photobleaching is a typical measure of the physical state of the material. The more the material bleaches the more the material has degraded thus leading to a device that functions poorly or fails to function altogether. In FIG. 3, the first 10,000 minutes shows the stability of the material in a 100% nitrogen atmosphere. After 10,000 minutes the sample chamber is opened and flooded with ambient air (20% oxygen, ˜80% nitrogen). After exposure to oxygen, the rate of photo-bleaching increases dramatically, which signifies dramatic degradation of the material's photostability. Other organic or polymer devices such as thermo-optical switches also suffer the same effect.

Additional devices that may be susceptible to degradation include planar, thermally tunable Bragg gratings, or inorganic LiNbO₃-based modulators of a Mach-Zehnder waveguide design. The Bragg gratings don't contain chromophores but still may need to be protected from the long-term effects of photo-oxidation. The device(s) can be also a micro-optic component containing a polymeric gel or optical path adhesive that is photo-oxidizable. Optical components that include optical adhesives, refractive index gels, splices between optical sub-components or assemblies, or fiber-waveguide (e.g., fiber-fiber, pigtail) or fiber-lens interface, low-loss material, or interferometer, can suffer from poor photostability in an atmosphere having high oxygen, water or hydrocarbon vapor content. Since optical adhesives or refractive index matching gels or other optical adhesives have been used to fill in the gap between splices and couplers, and are typically polymer or organic based, these components can decay overtime in an atmosphere with oxygen or water vapors. Also, when optical adhesives or gels absorb the light and heat up sufficiently, the materials can outgas or otherwise change properties.

In another aspect, the present invention pertains to methods for making the getters materials, as described above, and incorporating them into opto-electronic packages. The method comprises several steps. Prepare a mixture of mixed-oxide compounds. Precipitate a mixed metal hydroxide with a concentrated base solution of mixed bases, from the mixed-oxide mixture. Collect the hydroxide precipitate and wash with a liquid-phase solvent. Impregnate transition metal and metal oxides on and in the mixed oxide powder. Calcinate the hydroxide precipitate to the mixed oxide in flowing air. Activate the hydroxide precipitate. Shape the hydroxide precipitate into a form, and assemble said getter material in a package assembly. The getter material can have a shape that includes pellets, ribbons, beads, bricks, and bulk monoliths. The liquid-phase solvent is a dehydrating agent, preferably an alcohol. The activating step is by means of reducing agents.

In still another aspect, the present invention includes a method of packaging an opto-electronic device. The method comprises providing a regenerable sorbent as described herein, forming the sorbent into a getter, and assembling the getter in a package assembly.

The present invention has been described in detail and by way of examples of preferred embodiments. Persons skilled in the art, however, can appreciate that substitutions, modifications, and variations may be made to the present sorbents or alternative compositions and processes are permissible, as well as alternative uses for the invention without departing from the scope of the invention, as defined by the appended claims and their equivalents.

We claim:

1. A regenerable sorbent for removing trace amounts of oxygen from either a gas-stream or a closed system, the sorbent comprises:
a mixed-oxide material composed by weight of about 1% to about 99% Ce₂O₃, about 0% to about 99% ZrO₂, and 0% to about 25% RₓO_{y}, wherein RₓO_{y} is another metal oxide, and x and y are integers; and
at least one of the following transition metals: Fe, Co, Ni, Cu, Ru, Pd, Rh, Pt, Ir, Os, or their oxides or mixtures thereof in catalytic amount of 0% to about 10%, on a surface of said mixed oxide material.

2. The sorbent according to claim 1, wherein said cerium oxide content ranges from about 20% to about 95% by weight.

3. The sorbent according to claim 1, wherein said zirconium oxide content is 5-80% by weight.

4. The sorbent according to claim 3, said zirconium oxide content is about 40-50% by weight.

5. The sorbent according to claim 1, wherein said mixed-oxide material is of a single-phase metastable matrix.

6. The sorbent according to claim 1, wherein said RₓO_{y} is a transition metal or rare earth metal oxide.

7. The sorbent according to claim 5, wherein said RₓO_{y} is Y₂O₃, Sc₂O₃, Nd₂O₃, or Sm₂O₃.

8. The sorbent according to claim 1, wherein said transition metals and oxides thereof are of either Pd, Rh, Pt, Ir or a combination thereof in an amount of about 0.01 to 5% by weight.

9. The sorbent according to claim 1, wherein said mixed oxide material has a surface area ranging from about 0.1 m²/g to about 150 m²/g.

10. The sorbent according to claim 1, wherein said mixed oxide material has a crystal size ranging from about 1 nm to about 100 microns.

11. The sorbent according to claim 8, wherein said mixed oxide material has a crystal size ranging from about 4 nm to 90 microns.

12. The sorbent according to claim 1, wherein said sorbent can operate in a wide range of temperatures, from about −40° C. up to about 1200° C.

13. The sorbent according to claim 1, wherein said sorbent can operate in a temperature range from about either 0° C. or ambient room temperature (˜20° C.) to about 1000° C.

14. The sorbent according to claim 1, wherein said material has additional capacity to take up any oxygen that may seep through hermetical seals into an enclosed environment or container.

15. The sorbent according to claim 1, wherein after complete reduction of said material, the oxygen sorption capacity is at least 2 times greater than conventional sorbents per volume.

16. The sorbent according to claim 1, wherein the oxygen capacity is about 10-15 ml per gram.

17. The sorbent according to claim 1, wherein said sorbent can operate in noxious environments, which would otherwise poison conventional catalysts.

18. A method of preparing an oxygen sorbent, the method comprising:
a) preparing a mixture of mixed-oxide compounds;
b) precipitating a mixed metal hydroxide with a concentrated base solution of mixed bases, from said mixed-oxide mixture;
c) collecting said hydroxide precipitate and washing with a liquid-phase solvent;
d) calcinating said hydroxide precipitate to a mixed-oxide material in flowing air.

19. The method according to claim 18, the method further comprising impregnating metal or metal oxides on and in said mixed-oxide material; and activating said hydroxide precipitate or mixed oxide material.

20. The method according to claim 18, wherein a single-phase mixed oxide matrix of ceria and zirconia is produced, having a ceria content of up to about 95 mole %.

21. The method according to claim 20, wherein said ceria content in said mixed-oxide material is about 50-80 mole %.

22. The method according to claim 20, wherein said single-phase material is of a metastable mixed-oxide matrix.

23. The method according to claim 19, wherein said metal or metal oxides are of transition or precious metals, including at least one of the following: Fe, Co, Ni, Cu, Ru, Pd, Rh, Pt, Ir, Os, or their oxides or mixtures thereof in catalytic amount of 0% to about 10%.

24. The method according to claim 19, wherein said activating step is a reduction of said hydroxide precipitate or mixed-oxide material.

25. The method according to claim 18, wherein said mixture of mixed-oxide compounds includes an aqueous medium of at least a soluble cerium compound and at least a soluble zirconium compound.

26. The method according to claim 25, wherein said mixed-oxide compounds include soluble cerium (III) or cerium (IV) salts, or soluble zirconium salts.

27. The method according to claim 18, wherein said mixed-oxide mixture is incorporated into said base solution.

28. The method according to claim 18, wherein said base is ammonium hydroxide.

29. The method according to claim 18, wherein said base concentration ranges from about 1 M/L to 16 M/L.

30. The method according to claim 29, wherein said base concentration ranges from about 4 M/L to 8 M/L.

31. The method according to claim 18, wherein said liquid-phase solvent is a dehydrating agent.

32. The method according to claim 31, wherein said liquid-phase solvent is an alcohol.

33. The method according to claim 32, wherein said liquid-phase solvent is ethanol.

34. The method according to claim 18, wherein said hydroxide precipitate is washed for 2 to 6 cycles.

37. The method according to claim 19, wherein said activating step is by means of reduction at about 400° C. for about 4 hours.

38. The method according to claim 37, wherein said activating step uses hydrogen, carbon monoxide, hydrocarbon vapor, or other reducing agents.

39. The method according to claim 18, wherein said calcination step occurs at a temperature between about 250° C. to about 600° C.

40. The method according to claim 39, wherein said calcinating step occurs at a temperature between about 400° C. to about 500° C.

41. The method according to claim 18, wherein said calcinating step occurs for about 1-10 hours.

42. The method according to claim 41, wherein said calcinating step occurs for about 4 hours.

43. The method according to claim 18, wherein said sorbent can operate in noxious environments, which would otherwise poison conventional catalysts.

44. A process for producing a single-phase mixed oxide material in a ceria-zirconia system, the process comprising:
a) preparing a mixture of cerium and zirconium compounds in solution;
b) precipitating a mixed metal hydroxide with a concentrated base solution of mixed bases, from said mixed-oxide mixture by adding said mixed-oxide mixture into said base solution;
c) collecting said hydroxide precipitate and washing with a liquid-phase solvent;
d) calcinating said hydroxide precipitate to a mixed oxide material in flowing air.

45. A regenerable sorbent for removing trace amounts of oxygen from either a gas-stream or a closed system, the sorbent is made according to a method comprising:
a) preparing a mixture of mixed-oxide compounds;
b) precipitating a mixed metal hydroxide with a concentrated base solution of mixed bases, from said mixed-oxide mixture by adding said mixed-oxide mixture into said base solution;
c) collecting said hydroxide precipitate and washing with a liquid-phase solvent;
d) calcinating said hydroxide precipitate to a mixed oxide material in flowing air.

46. A device comprising an enclosure, a component susceptible to degradation from oxygen, and a getter material comprising a mixed-oxide carrier composed by weight of about 20% to about 95% Ce₂O₃, about 5% to about 90% ZrO₂, and 0% to about 25% RₓO_{y}, wherein RₓO_{y} is another metal oxide, and x and y are integers; and at least one of the following transition metals: Fe, Co, Ni, Cu, Ru, Pd, Rh, Pt, Ir, Os, or their oxides or mixtures thereof, on a surface of said mixed oxide carrier, and an inorganic binder and components chosen from the group including MCM-22, -24, -30, -41, zeolite type A, X, Y, L, ZSM-5, mordenite, cloverite, porous silica, porous borosilicate, activated carbon, activated alumina, porous alumina, and mixtures thereof.

47. The device according to claim 46, wherein said getter material can absorb residue oxygen in hermetic packages to levels below 1 part per trillion (ppt), over a temperature range from about −40° C., through ambient room temperature, to about 500° C.

48. The device according to claim 46, wherein said mixed-oxide material is of a single-phase metastable matrix.

49. The device according to claim 46, wherein said RₓO_{y} is a transition metal or rare earth metal oxide, including any one of the following: Y₂O₃, Sc₂O₃, Nd₂O₃, or Sm₂O₃.

50. The device according to claim 46, wherein said transition metals and oxides thereof are of either Pd, Rh, Pt, Ir or a combination thereof in an amount of about 0.01 to 5% by weight.

51. The device according to claim 46, wherein said device is an opto-electonic telecommunication module.

52. The device according to claim 46, wherein said device is an organic or polymer device.

53. The device according to claim 46, wherein said device includes a modulator, wavelength multiplexer or demultiplexer, coupler, optical switch, organic or polymer light emitting diode (OLED).

54. The device according to claim 46, wherein said device is a polymeric thermo-optical switch.

55. The device according to claim 46, wherein said device is an electro-optic modulator based on a planar Mach-Zehnder waveguide design.

56. The device according to claim 46, wherein the device is a micro-optic component containing a polymeric gel or optical path adhesive that is photo-oxidizable.

57. The device according to claim 46, wherein said components includes optical adhesive, refractive index gels, splices between optical sub-components, fiber-waveguide or fiber-lens interface, low-loss material, or interferometer.

58. A hermetically sealed opto-electronic package comprising:
a sealed enclosure in which there is an atmosphere and a component that is adversely affected by the presence of gaseous oxygen or other impurities in said atmosphere; and
a getter material comprising a mixed-oxide material composed by weight of about 20% to about 95% Ce₂O₃, about 5% to about 80% ZrO₂, and 0% to about 25% RₓO_{y}, wherein RₓO_{y} is another metal oxide, and x and y are integers; and at least one of the following transition metals: Fe, Co, Ni, Cu, Ru, Pd, Rh, Pt, Ir, Os, or their oxides or mixtures thereof in catalytic amount, on a surface of said mixed oxide material, and an inorganic binder and components chosen from the group including MCM-22, -24, -30, -41, zeolite type A, X, Y, L, ZSM-5, mordenite, cloverite, porous silica, porous borosilicate, activated carbon, activated alumina, porous alumina, and mixtures thereof.

59. The package according to claim 58, wherein said getter material can absorb residue oxygen in hermetic packages to levels below 1 part per trillion (ppt), over a temperature range from about −40° C., through ambient room temperature, to about 500° C.

60. A method of providing a virtually O₂-free atmosphere in an opto-electronic device package, the method comprises:
a) providing a photonic device;
b) providing a housing;
c) providing a getter material comprising a mixed-oxide material composed by weight of about 20% to about 95% Ce₂O₃, about 5% to about 80% ZrO₂, and 0% to about 25% RₓO_{y}, wherein RₓO_{y} is another metal oxide, and x and y are integers; and at least one of the following transition metals: Fe, Co, Ni, Cu, Ru, Pd, Rh, Pt, Ir, Os, or their oxides or mixtures thereof in catalytic amount, on a surface of said mixed oxide material;
d) enclosing said photonic device and said getter within said housing; and
e) removing oxygen and other contaminant vapors from said opto-electronic component.

61. The method according to claim 60, wherein said getter material further comprises an inorganic binder and components chosen from the group including MCM-22, -24, -30, -41, zeolite type A, X, Y, L, ZSM-5, mordenite, cloverite, porous silica, porous borosilicate, activated carbon, activated alumina, porous alumina, and mixtures thereof.

62. The method according to claim 60, further comprising locating said getter material in a package assembly.

63. The method according to claim 60, wherein said getter material can absorb residue oxygen in hermetic packages to levels below 1 part per trillion (ppt), over a temperature range from about −40° C., through ambient room temperature, to about 500° C.

64. An opto-electronic system comprising:
a photonic device;
a housing; and
a getter material comprising a mixed-oxide material composed by weight of about 20% to about 95% Ce₂O₃, about 5% to about 80% ZrO₂, and 0% to about 25% RₓO_{y}, wherein RₓO_{y} is another metal oxide, and x and y are integers; and at least one of the following transition metals: Fe, Co, Ni, Cu, Ru, Pd, Rh, Pt, Ir, Os, or their oxides or mixtures thereof in catalytic amount, on a surface of said mixed oxide material.

65. The system according to claim 64, wherein said getter material further comprises an inorganic binder and components chosen from the group including MCM-22, -24, -30, -41, zeolite type A, X, Y, L, ZSM-5, mordenite, cloverite, porous silica, porous borosilicate, activated carbon, activated alumina, porous alumina, and mixture thereof.

66. A photonic component getter comprising:
a regenerable sorbent, the sorbent comprises: a mixed-oxide material composed by weight of about 20% to about 95% Ce₂O₃, about 5% to about 80% ZrO₂, and 0% to about 25% RₓO_{y}, wherein RₓO_{y} is another metal oxide, and x and y are integers; and
at least one of the following transition metals: Fe, Co, Ni, Cu, Ru, Pd, Rh, Pt, Ir, Os, or their oxides or mixtures thereof in catalytic amount, on a surface of said mixed oxide material; assemblying said getter material in a package assembly.

67. The getter according to claim 66, wherein said sorbent further comprises an inorganic binder and components chosen from the group including MCM-22, -24, -30, -41, zeolite type A, X, Y, L, ZSM-5, mordenite, cloverite, porous silica, porous borosilicate, activated carbon, activated alumina, porous alumina, and mixtures thereof.

68. A method of making a photonic component getter material, the method comprising:
a) preparing a mixture of mixed-oxide compounds;
b) precipitating a mixed metal hydroxide with a concentrated base solution of mixed bases, from said mixed-oxide mixture;
c) collecting said hydroxide precipitate and washing with a liquid-phase solvent;
d) impregnating metal oxides on and in said mixed oxide powder;
e) calcinating said hydroxide precipitate to said mixed oxide in flowing air; and
f) activating said hydroxide precipitate;
g) shaping said hydroxide precipitate into a form;
h) assembling said getter material in a package assembly.

69. The method according to claim 68, wherein said getter material has a form that includes pellets, ribbons, beads, bricks, and bulk monoliths.

70. The method according to claim 68, wherein said liquid-phase solvent is a dehydrating agent.

71. The method according to claim 70, wherein said liquid-phase solvent is an alcohol.

72. The method according to claim 68, wherein said activating step is by means of reducing agents.

73. A method of packaging an opto-electronic device, the method comprising:
providing a regenerable sorbent, the sorbent comprises: a mixed-oxide material composed by weight of about 20% to about 95% Ce₂O₃, about 5% to about 80% ZrO₂, and 0% to about 25% RₓO_{y}, wherein RₓO_{y} is another metal oxide, and x and y are integers; and
at least one of the following transition metals: Fe, Co, Ni, Cu, Ru, Pd, Rh, Pt, Ir, Os, or their oxides or mixtures thereof in catalytic amount, on a surface of said mixed oxide material; assemblying said sorbent in a package assembly.

74. The method according to claim 73, wherein said sorbent further comprises an inorganic binder and components chosen from the group including MCM-22, -24, -30, -41, zeolite type A, X, Y, L, ZSM-5, mordenite, cloverite, porous silica, porous borosilicate, activated carbon, activated alumina, porous alumina, and mixtures thereof.

75. The method according to claim 73, wherein the method further comprises forming the sorbent into a shape.

76. The method according to claim 75, wherein said shape includes beads, pellets, granules, ribbons, slab, brick, ring, sheet or other bulk forms.

77. The method according to claim 73, further includes placing said getter into a porous getter housing.
